(19) United States
(12) Patent Application Publication
(10) Pub. No.: US 2017/0173907 A1
(43) Pub. Date: Jun. 22, 2017

(54) SELF CORRECTING TIRE BUFFING APPARATUS AND METHOD

(71) Applicant: Bridgestone Bandag, LLC, Muscatine, IA (US)

(72) Inventor: James A. Kendall, JR., Muscatine, IA (US)

(21) Appl. No.: 14/972,251

(22) Filed: Dec. 17, 2015

(51) Int. Cl. B29D 30/54; G01B 11/14; G05B 15/02; G01B 11/22

(52) U.S. Cl. CPC B29D 30/54; G01B 11/22; G01B 11/14; G05B 15/02; B29D 2030/541

(57) ABSTRACT

Systems and methods of buffing tire casings are provided. A tire buffing machine includes a tire hub assembly selectively rotating a mounted casing, a buffer configured to buff the casing, a first measurement subsystem with at least one electromagnetic transmitter and sensor directed toward at least one belt in the casing, a second measurement subsystem directed toward a pre-buff location and a post-buff location on the casing surface, and an electronic controller. The controller determines at least one belt depth based on electromagnetic transmitter and sensor data received by the first measurement subsystem, determines an amount of removed casing material based on pre-buff casing distance data and post-buff casing distance data received by the second measurement subsystem, and adjusts the operation of the buffer based on the at least one belt depth and the amount of removed casing material.

### TECHNICAL FIELD

The application has been filed concurrently with the application of John Lindsay titled “Automated Tire Buffing Identification Apparatus and Method,” which is herein incorporated by reference in full.

The present invention relates generally to devices and methods for retreading tires, and more particularly to devices and methods for tire buffing.

### BACKGROUND

A tire casing selected for retreading may be buffed to remove excess rubber and provide a substantially evenly textured crown for receiving a tread strip or other tread. Tire casings may include a belt package (a package of steel belts or cables) underlying the road-engaging surface (e.g., the original tread) of the tire. The casing may be buffed to leave only a predetermined thickness, e.g., 3/32 of an inch, of material remaining over the top belt. The shoulder of the casing may be also buffed (trimmed) to eliminate or reduce voids or patterns in the shoulder created by the original tread, and to provide, typically, a relatively straight profile between the casing side walls and the crown.

A cured tread strip, which may be of a width corresponding to the width of the crown of the casing, may be cut to the length corresponding to the casing circumference and disposed over the casing crown. Continuous replacement treads in the shape of a ring (i.e., ring treads) have also been used to retread the buffed casing. Thereafter, the assembly may be placed within a curing chamber and subjected to elevated pressure and temperature for a predetermined period of time. The combination of exposure to elevated pressure and temperature for a duration of time binds the cushion gum to both the tire casing and the new tire tread.

The shape and contour of the tire casing being buffed may be important to determining the necessary buffing operations that need to be performed. Some buffing machines are manually operated such that the final product of buffing is dependent on the skill of the operator. In other situations, data pertinent to buffing is stored in the buffing machine and such data may be extracted by the operator for proper buffing to proceed. If the shoulder areas are not sufficiently buffed and trimmed, the tread edges may come loose and/or the cushion gum extending beyond the tread edges will not bond to the casing shoulder. Such problems can reduce the longevity of the retreaded tire and adversely impact the appearance of the retreaded tire. In addition, if the crown surface of a tire casing is overbuffed and the belt package is exposed, the tire casing may be irrecoverably damaged. Further, tire casings are variable in size and shape across brands, within brands, and even as casings age. As such, errors and damage occur during buffing processes even if a tire casing is accurately identified and buffed within corresponding, standard parameters.

Thus, there exists a need for a tire buffing machine capable of accounting for variance across tire casings during the buffing process.

### SUMMARY

A tire buffing machine may include a tire hub assembly selectively rotating a casing mounted thereon, a buffer configured to buff the casing mounted on the tire hub assembly, a first measurement subsystem, a second measurement subsystem, and an electronic controller. The first measurement subsystem includes at least one electromagnetic transmitter and sensor directed toward at least one belt in the casing. The second measurement subsystem includes a first distance sensor directed toward a pre-buff location on a casing surface and a second distance sensor directed toward a post-buff location on the casing surface. The electronic controller may be communicatively coupled to the buffer, the first measurement subsystem, and the second measurement subsystem. The electronic controller may be programmed to determine at least one belt depth based on electromagnetic transmitter and sensor data received by the first measurement subsystem. The electronic controller may further be programmed to determine an amount of removed casing material based on pre-buff casing distance data and post-buff casing distance data received by the second measurement subsystem. The electronic controller may be programmed to adjust the operation of the buffer based on the at least one belt depth and the amount of removed casing material.

In some instances, a tire buffing machine includes a controller that may enable the tire buffing machine to buff a casing while monitoring the location of a belt package disposed therein, the controller including instructions stored on non-transient data media causing the controller to perform operations. The operations may include maintaining a database containing a plurality of casing profiles, each casing profile including corresponding buffing parameters. The operations may further include operating a buffer to buff the casing in accordance with buffing parameters associated with one of the plurality of casing profiles. The operations may include determining at least one belt depth based on electromagnetic transmitter and sensor data received by a first measurement subsystem comprising at least one electromagnetic transmitter and sensor. The operations may further include determining an amount of removed casing material based on pre-buff casing distance data and post-buff casing distance data received by a second measurement subsystem comprising a first distance sensor oriented towards a pre-buff location on the casing and a second distance sensor oriented towards a post-buff location on the casing. The operations may include adjusting the operation of the buffer based on the at least one belt depth and the amount of removed casing material.

In some embodiments, a method may be used to manufacture a retreaded tire casing. The method may include maintaining, in a database, a plurality of casing profiles, each casing profile including corresponding buffing parameters. The method may further include operating a buffer to buff the casing in accordance with buffing parameters in one of the plurality of casing profiles. The method may include determining, by a controller, at least one belt depth based on electromagnetic transmitter and sensor data received by a first measurement subsystem comprising at least one electromagnetic transmitter and sensor. The method may further include determining, by the controller, an amount of removed casing material based on pre-buff casing distance data and post-buff casing distance data received by a second measurement subsystem comprising a first distance sensor oriented towards a pre-buff location on the casing and a second distance sensor oriented towards a post-buff location on the casing. The method may include adjusting, by the controller, the operation of the buffer based on at least one belt depth and the amount of removed casing material.

The features of the present invention will become apparent to one of ordinary skill in the art upon reading the detailed description and claims, in conjunction with the accompanying drawings, provided herein. The scope of this disclosure includes various changes and modifications to the embodiments without departing from the spirit and scope of the present invention.

### BRIEF DESCRIPTION OF THE DRAWINGS

FIG. 1 is a schematic view of a tire sensing and buffing apparatus.

FIG. 2 is a top plan view of a tire sensing and buffing apparatus along with a tire casing mounted to a hub assembly.

FIG. 3A is a frontal view of an example arrangement of the tire sensing and buffing apparatus of FIG. 2.

FIG. 3B is a side view of the tire sensing and buffing apparatus of FIG. 3A, including a tire casing mounted to a hub assembly.

FIG. 4A is a frontal view of another example arrangement of the tire sensing and buffing apparatus of FIG. 2.

FIG. 4B is a top view of the tire sensing and buffing apparatus of FIG. 4A, including a tire casing mounted to a hub assembly.

FIG. 5 is a block flow chart diagram of a method of buffing a tire casing, according to an example embodiment.

### DETAILED DESCRIPTION

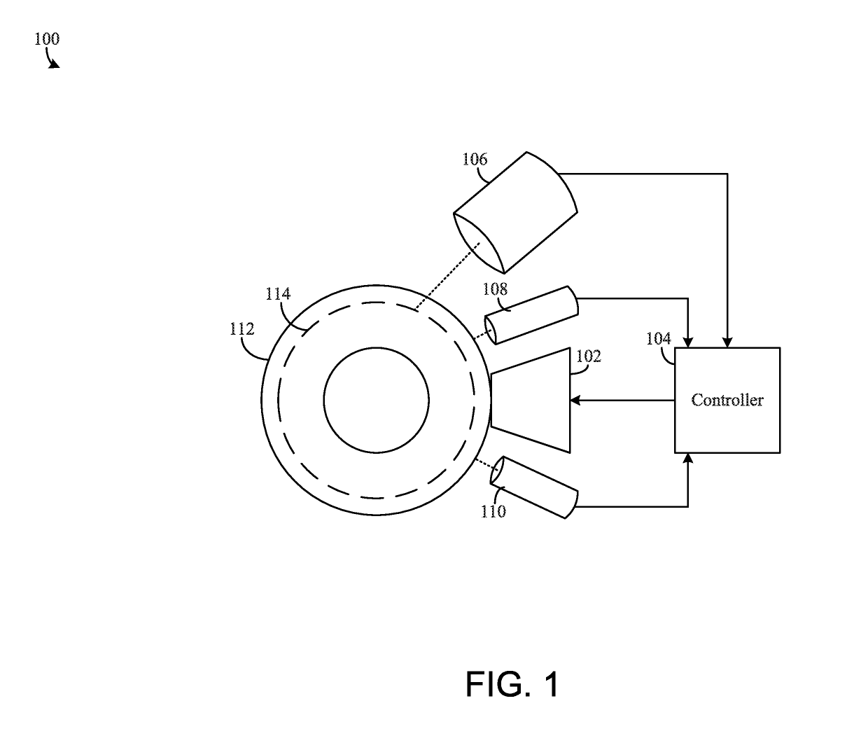

An illustrative tire buffing apparatus 100 is shown in FIG. 1. The apparatus 100 includes a rasp pedestal 102, a controller 104, a first measurement subsystem including a belt sensor 106, and a second subsystem including a first distance sensor 108 and a second distance sensor 110.

The rasp pedestal 102 is configured to remove material from a tire casing 112 to predetermined tire casing parameters with a desired surface texture. In various embodiments, the rasp pedestal 102 may include a rasp head housing a rasp or a rotary blade configured to strip material from outer surfaces of the tire casing 112. The rasp head may further include a texturing brush, which may be applied to casing surfaces to impart a specified texture to crown and shoulder portions of the tire casing 112 to facilitate a subsequent retreading process.

The controller 104 is a computing system communicatively coupled to the other components of the apparatus 100, and is configured to measure the tire casing 112 and correct the operation of the rasp pedestal 102 during a buffing process. In some embodiments, the operations discussed with respect to the controller 104 are performed by a plurality of separate controllers acting as a single controller, or a plurality of computing components of the same controller that operate the buffer and measure the tire casing 112.

In some arrangements, the controller 104 includes an operator input/output (“I/O”) device and a database. The operator I/O includes hardware and associated logics sufficient to allow the controller 104 to exchange information with a human operator. For example, an input aspect of the operator I/O of the controller 104 may include any of a mechanical keyboard, a touchscreen, a microphone, a keypad, and so on. The output aspect of the operator I/O may include a digital display, one or more illuminating signal lights, speakers, and so on. The database includes a non-transient data storage medium, which may include, for example, local hard drives or a networked data server. The database stores instructions carried out by the controller 104, including instructions for buffing procedures. The database may also include information relating to a plurality of buffing parameter profiles (e.g., desired crown and shoulder characteristics, minimum belt depths, etc.) corresponding to a plurality of tire casing sizes and specifications. As such, an operator may interact with the controller 104 via the operator I/O to select an appropriate casing profile and initiate a buffing procedure.

The controller 104 is electrically coupled to the rasp pedestal 102, and may be configured to adjust the buffing process while the rasp pedestal 102 is in operation. The rasp pedestal 102 may be coupled to one or more rails, hinges, pivots, etc. and corresponding actuators configured to allow the rasp pedestal 102 and/or components disposed thereon (e.g., a rasp head) various ranges of movement relative to the tire casing 112. In addition, the controller 104 may be communicatively coupled to one or more motors configured to effect various cut depths and movement patterns of the rasp disposed on the rasp pedestal 102. The controller 104 can be associated with a current sensor which senses the current draw of a rasp drive motor for rotating the rasp head and the texturing device. The rasp drive motor can have a predetermined full-load capacity at which its current draw is a particular value and at which the motor can remove material from the tire casing 112 at an efficient rate while preventing damage to the motor or other components of the tire buffer. The value of the predetermined target current draw can be based upon such considerations as the capabilities of the motor driving the cutter, the maximum depth of cut for the selected cutter, the maximum traverse speed the buffer is capable of generating, and the wear of the cutter itself. The controller 104 can compare the actual current draw of the rasp drive motor to the calculated target current draw and determined whether the actual current draw is equal to the target current draw. If the actual and target current draws are different, the controller can move the rasp pedestal 102 at different rates of speed by selectively controlling the rasp moving assembly to adjust the actual current draw such that it moves toward the target current draw. The traverse rate of speed of the rasp pedestal 102 can be increased to increase the actual current draw of the motor and decreased to decrease the actual current draw of the motor.

The controller 104 is in data receiving communication with each of the belt sensor 106, the first distance sensor 108, and the second distance sensor 110. In some arrangements, each of the belt sensor 106, the first distance sensor 108, and the second distance sensor 110 are mounted to the rasp pedestal 102, and are configured to measure distances with respect to the rasp pedestal 102.

The belt sensor 106 is a measurement device configured to determine the depth of a set of belts 114 within the tire casing 112. The belt sensor 106 may include any of a plurality of measurement devices suited to determine distance to a metallic component (e.g., the belts 114) relative to the sensor itself. In some arrangements, the belt sensor 106 is configured to determine the distance of the belts 114 relative to the rasp pedestal 102, and in turn, the rasp disposed within the rasp pedestal 102. In one arrangement, the belt sensor 106 includes an electromagnetic transmitter and sensor (e.g., a magnetic field sensor, an inductive sensor, etc.), and is suited to measure the time between an electromagnetic transmission and a receipt of a corresponding electromagnetic reflection. In such arrangements, the electromagnetic transmission may be selected to be reflected by materials disposed in the belts 114. As such, the belt sensor 106 may be able to provide the controller 104 with data corresponding to electromagnetic reflection time with respect to the belts 114. In turn, the controller 104 may be configured to use data provided by the belt sensor 106 to determine the distance of the belts 114 relative to the rasp pedestal 102.

The first distance sensor 108 and the second distance sensor 110 are configured to measure distances to a pre-buff location and a post-buff location on the surface of the tire casing 112 with respect to the rasp disposed in the rasp pedestal 102. In various arrangements, each of the first distance sensor 108 and the second distance sensor 110 are configured to measure distances via laser, optical, infrared, etc. devices. For example, in one arrangement, each of the first distance sensor 108 and the second distance sensor 110 include laser sensors oriented toward a center portion of the tire casing 112 crown. In such an arrangement, the first sensor 108 may collect data corresponding to the distance from the rasp pedestal 102 to the crown surface of the tire casing 112 before being buffed, and the second sensor 110 may collect data corresponding to the distances from the rasp pedestal 102 to the crown surface of the tire casing 112 after being buffed. The controller 104 may receive data from the first distance sensor 108 and the second distance sensor 110 to determine the amount of casing material removed by the rasp in the rasp pedestal 102.

As such, in operation, the controller 104 may be supplied with three types of distance data from the sensors: (1) distance between the rasp pedestal 102 and the pre-buff crown surface of the tire casing 112 (e.g., via the first distance sensor 108); (2) distance between the rasp pedestal 102 and the post-buff crown surface of the tire casing 112 (e.g., via the second distance sensor 110); and (3) distance between the rasp pedestal 102 and the set of belts 114 within the tire casing 112 (e.g., via the belt sensor 106). In other words, the controller 104 may be made aware of the depth of the belts 114 before being buffed at the rasp (i.e., via the belt sensor 106 and the first distance sensor 108), and the depth of the belts 114 after being buffed by the rasp (i.e., via the belt sensor 106 and the second distance sensor 110), and therefore the amount of casing material removed (i.e., the difference). In response to distance data received, the controller 104 may adjust the operation of the rasp in the rasp pedestal 102 (e.g., to reduce a cut depth if the amount of removed casing material is unexpectedly high). As such, the controller 104 may be able to adjust the buffing process to accommodate variances in the belt location 114 across various similarly sized casings, variances in casing material properties (e.g., density, hardness, etc.). Additional features and details of the buffing apparatus 100 are discussed below.

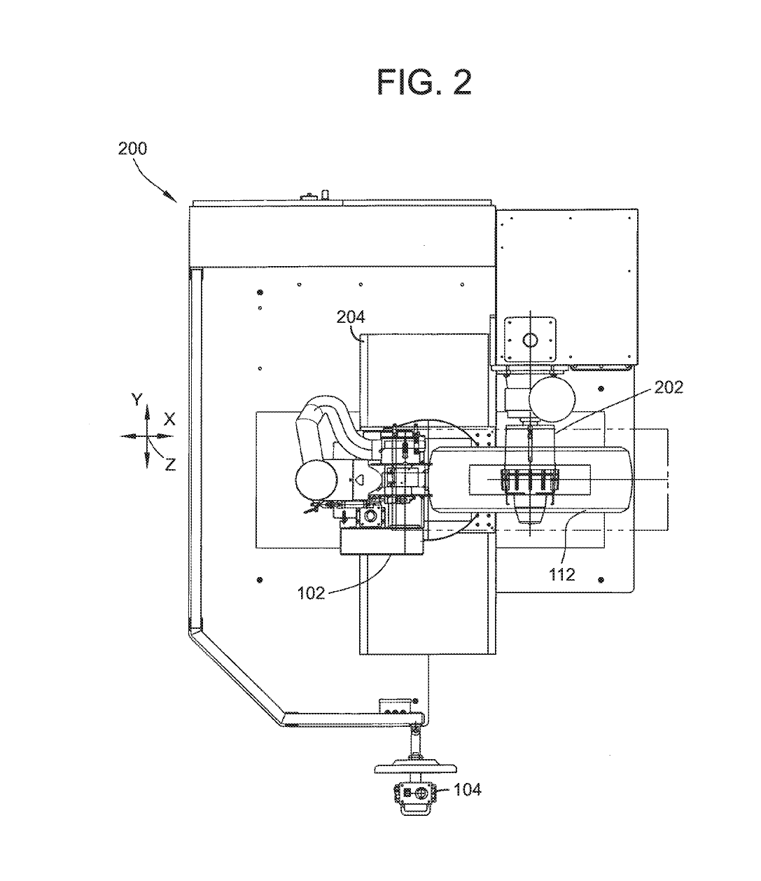

Referring now to FIG. 2, a buffing apparatus 200 includes example arrangements of the components of the buffing apparatus 100, including the rasp pedestal 102, the controller 104, and the tire casing 112. The buffing apparatus 200 further includes a tire hub assembly 202 and a pedestal movement assembly 204.

The tire hub assembly 202 is configured to provide a mount for the tire casing 112 during the buffing process. In some embodiments, the tire hub assembly 202 is configured to engage a center aperture in the tire casing 112 (i.e., similar to a rim engaging the tire casing), orient the tire casing 112 on a center axis (i.e., a rotational axis of the tire casing), and inflate the tire casing 112. For example, in some embodiments, the tire hub assembly 202 includes an expandable tire chuck (i.e., an expandable rim) having a plurality of radial pistons (e.g., pneumatically or hydraulically actuated). The tire chuck of the tire hub assembly 202 may be disposed in a contracted configuration during an initial casing mounting process, and may subsequently expand (i.e., via actuation of the plurality of radial pistons) to engage a center aperture (e.g., defined by a casing bead) of the tire casing 112. The tire chuck may be further configured to expand in a manner sufficient to orient the tire casing 112 on a center axis. In addition, the tire hub assembly 202 may include an airflow line in fluid providing communication with an interior portion of the tire casing 112, thereby allowing the tire casing 112 to be inflated. The tire hub assembly 202 may further be operatively coupled to a motor with a rotational output at the tire chuck, and as such, the tire hub assembly 202 may cause the tire casing 112 to rotate during a buffing process. In some arrangements, the tire hub assembly 202 is electrically coupled to the controller 104, which may control the various operations discussed above.

The pedestal movement assembly 204 is configured to provide a range of motion for the rasp pedestal 102. The pedestal movement assembly 204 may be configured to allow the rasp pedestal 102 to travel along an X and a Y axis to approach and position the rasp or brush with respect to a mounted casing. The pedestal movement assembly 204 may further allow the rasp pedestal 102 to rotate about a Z axis (i.e., extending out of FIG. 2, perpendicular to the X and Y axes) to allow the rasp disposed therein to engage the tire casing 112 at specified angles, for example to buff shoulder portions of the casing. In one arrangement, the pedestal movement assembly 204 includes respective sets of rails and bearings corresponding to the X and Y axes, and a pivot hinge disposed at a base portion of the rasp pedestal 102 to enable Z axis rotation.

In operation, an operator may dispose the tire casing 112 onto a contracted tire chuck of the tire hub assembly 202. The operator may use the operator I/O of the controller 104 to identify an appropriate casing profile to be applied by the apparatus 200, and initiate a buffing process. The controller 104 may then cause the tire chuck of the tire hub assembly 202 to expand, engage, and orient the tire casing 112 about a center axis. The rasp pedestal 102 may approach the tire casing 112 along an X axis via the pedestal movement assembly 204, and perform a buffing process pursuant to the selected casing profile.

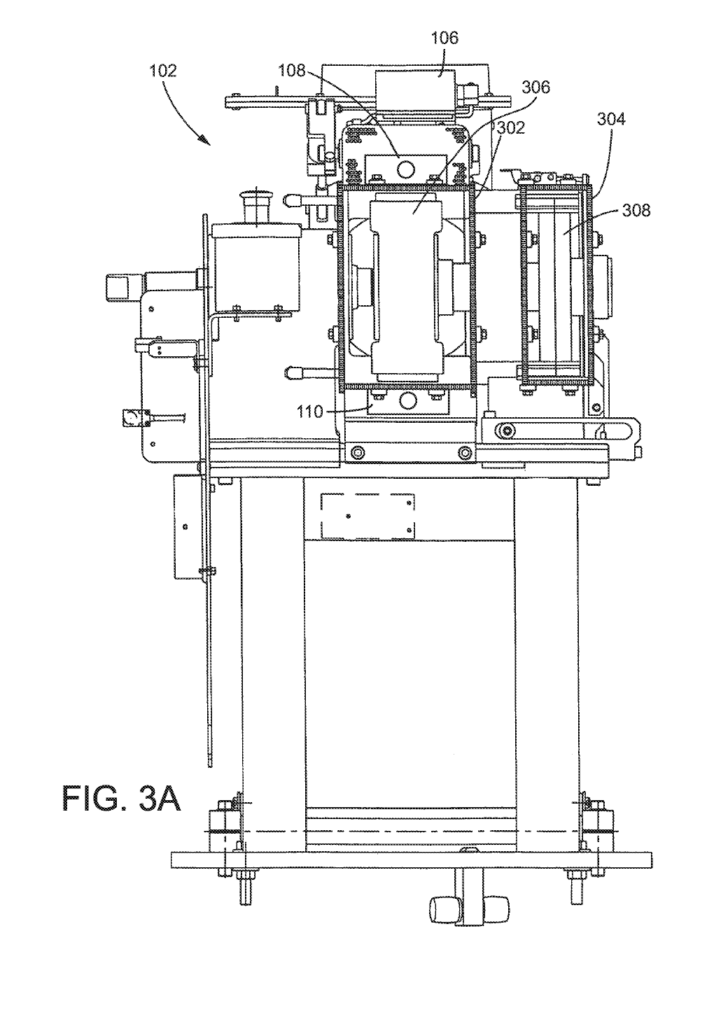

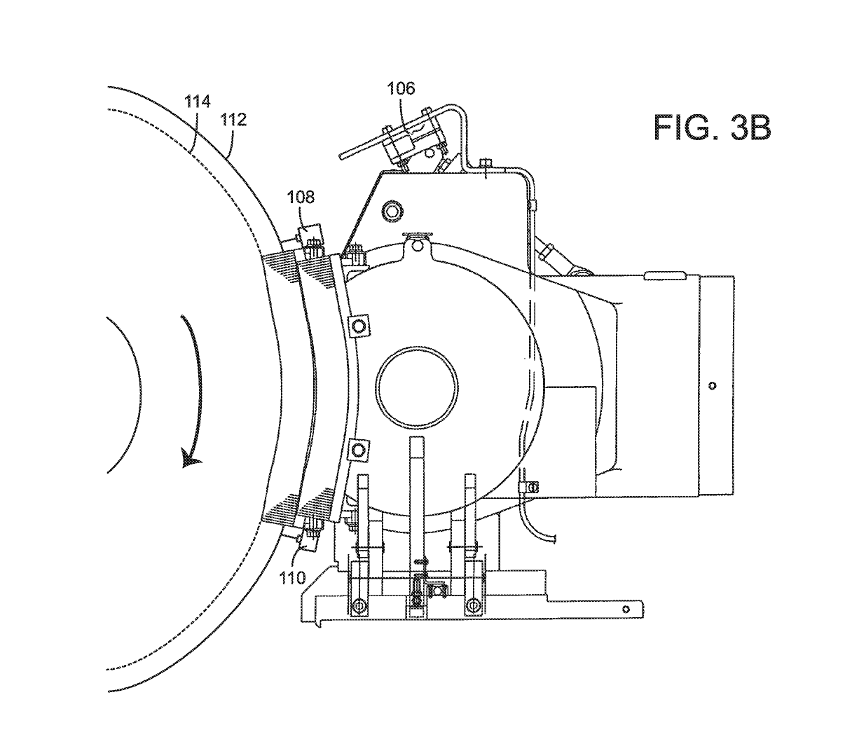

Referring now to FIG. 3A, example placements of the belt sensor 106, the first distance sensor 108, and the second distance sensor 110 on the rasp pedestal 102 are shown. In the arrangement shown, the rasp pedestal 102 includes a rasp housing 302 and a brush housing 304. The rasp housing 302 is an open-ended compartment containing a rasp 306 within that is exposed toward the tire casing 112. The brush housing 304 is also an open-ended compartment, and contains a texturing brush 308 within and exposed toward the tire casing 112. In some arrangements, the rasp housing 302 and the brush housing 304 are disposed side-by-side on the rasp pedestal 102. As such, in operation, the rasp pedestal 102 may be positioned to engage the rasp 306 to the tire casing 112 during a buffing process, and may subsequently shift laterally to engage the texturing brush 308 to the tire casing 112 during a texturing process.

In the arrangement shown in FIG. 3A, the first distance sensor 108 and the second distance sensor 110 are mounted on respective outer portions of the rasp housing 302. The first distance sensor 108 may be disposed on an upper exterior portion of the rasp housing 302 adjacent to the exposed portion of the rasp 306. The first distance sensor 108 may be directed toward a pre-buff crown surface of the tire casing 112 with respect to a direction of rotation of the tire casing 112 (i.e., a point on the crown surface prior to rotating into the rasp 306). In turn, the second distance sensor 110 may be disposed on a lower exterior portion of the rasp housing 302 adjacent to the exposed portion of the rasp 306. As such, the second distance sensor 110 may be directed to a post-buff crown surface of the tire casing 112 with respect to the direction of rotation of the tire casing 112 (i.e., a point on the crown surface after rotating into the rasp 306).

The belt sensor 106 is shown mounted above the first distance sensor 108 on the rasp pedestal 102. In various other arrangements, the belt sensor 106 may be mounted above, below, or to the side of the rasp housing 302. In some arrangements, the belt sensor 106 shares a longitudinal plane (e.g., defined by the Z and X axes) with the first distance sensor 108 and the second distance sensor 110. In such arrangements, the pre-buff distance, post-buff distance, and belt depth may be determined along a common outer circumference of the tire casing 112 (e.g., the center of the crown circumference).

Referring now to FIG. 3B, in operation during the buffing process, the tire casing 112 is engaged to the rasp 306 at the rasp housing 302. The tire hub assembly 202 may be configured to rotate the tire casing 112 as the rasp 306 removes casing material from the outer circumference of the tire casing 112. The first distance sensor 108 provides the controller 104 with data corresponding to the distance from the first distance sensor 108 to a pre-buff portion of the surface of the tire casing 112. The second distance sensor 110 in turn provides the controller 104 with data corresponding to the distance from the second distance sensor 110 to a post-buff portion of the surface of the tire casing 112. The belt sensor 106 provides the controller 104 with data corresponding to the depth of the belts 114 within the tire casing 112. The difference between the distance from the first distance sensor 108 to the tire casing 112 surface at a pre-buff location and the distance between the second distance sensor 110 and the tire casing 112 surface at a post-buff location provides an amount of removed casing material. The controller 104 may check the amount of removed casing material with the belt depth provided by the belt sensor 106, and adjust the cut depth of the buffer accordingly.

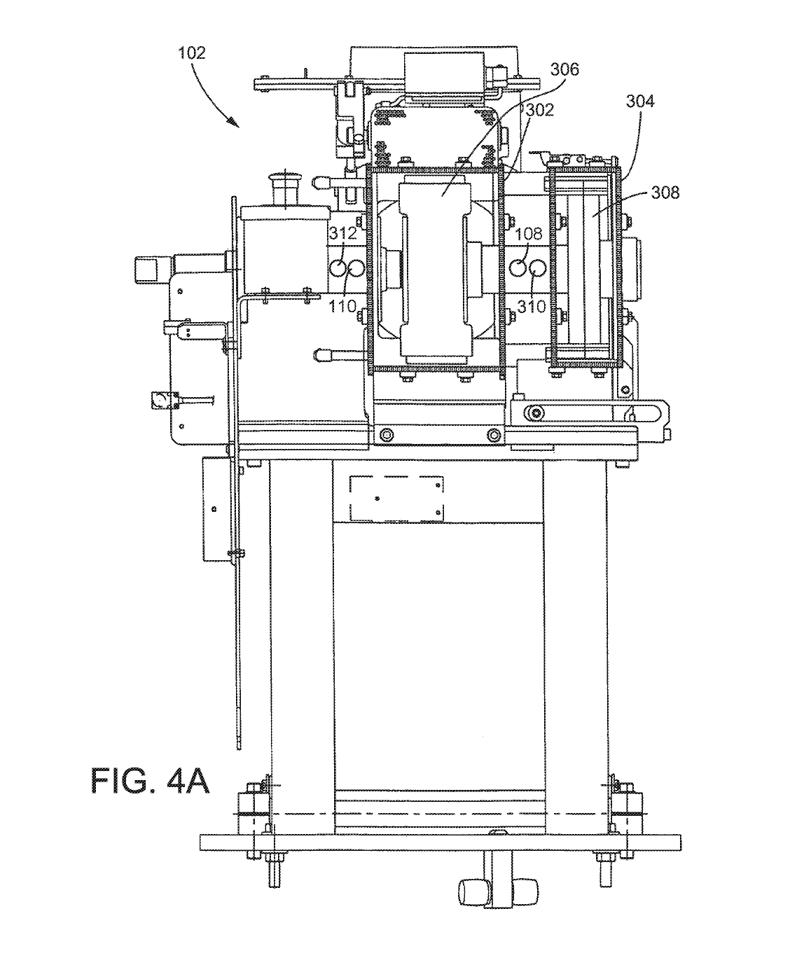

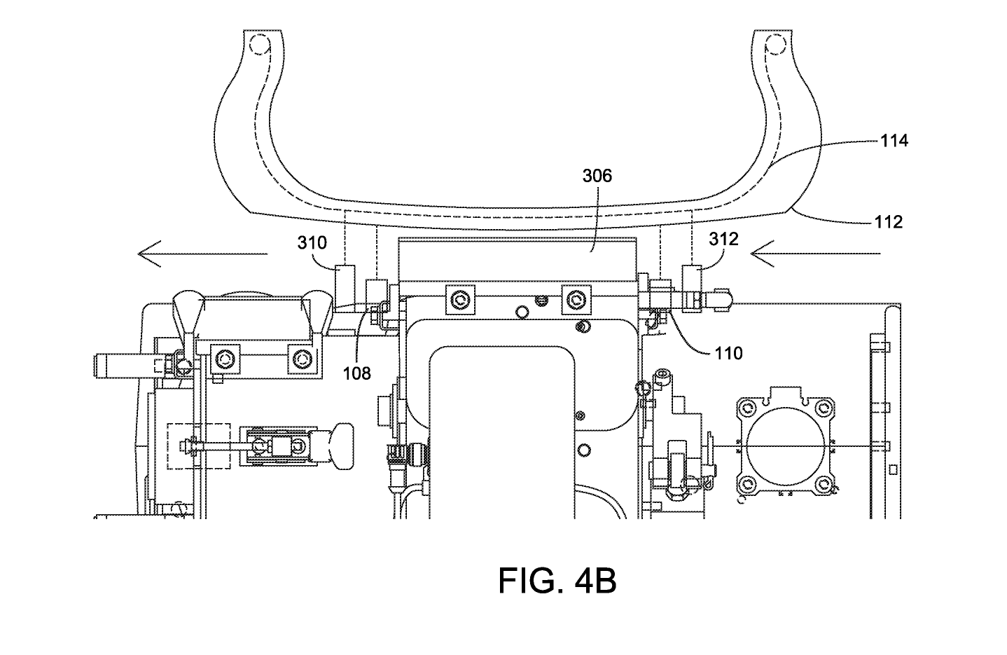

FIG. 4A shows an alternative arrangement of the sensors 106, 108, 110. In the arrangement shown in FIG. 3B, the first distance sensor 108 and the second distance sensor 110 are disposed on respective sidewall portions on either side of the rasp housing 302. In addition, the belt sensor 106 in FIG. 3B includes a first belt sensor 310 disposed adjacent to the first distance sensor 108 and a second belt sensor 312 disposed adjacent to the second distance sensor 110. As such, the first distance sensor 108 and the first belt sensor 310 may be oriented toward and generate measurements with respect to a lateral pre-buff location of the mounted tire casing 112, and the second distance sensor 110 and the second belt sensor 312 may be oriented toward and generate measurements with respect to a lateral post-buff location of the mounted tire casing 112. In some arrangements, one or more of the sensors 108, 110, 310, 312 are disposed along a common latitudinal axis. Further, in some such arrangements, one or more of the sensors 108, 110, 310, 312 are disposed along a latitudinal axis defined by the rotational axis of the rasp 306.

FIG. 4B shows a top-down view of the arrangement discussed with respect to FIG. 4A, further including an example placement of a tire casing 112. In the arrangement shown in FIG. 4B, the tire casing 112 is engaged to the rasp 306 at the rasp housing 302. The tire hub assembly 202 may be configured to rotate the tire casing 112 as the rasp 306 removes casing material from the outer circumference of the tire casing 112. While the rasp 306 is traveling in the indicated direction, the first distance sensor 108 provides the controller 104 with data corresponding to the distance from the first distance sensor 108 to a pre-buff portion of the surface of the tire casing 112. The second distance sensor 110 in turn provides the controller 104 with data corresponding to the distance from the second distance sensor 110 to a post-buff portion of the surface of the tire casing 112. The first belt sensor 310 provides the controller 104 with data corresponding to the depth of the belts 114 within the tire casing 112 prior to the rasp removing any casing material from the casing 112. The second belt sensor 312 provides the controller 104 with data corresponding to the depth of the belts 114 within the tire casing 112 after the rasp removed a set amount of casing material from the casing 112. The difference between the distance from the first distance sensor 108 to the tire casing 112 surface at a pre-buff location and the distance between the second distance sensor 110 and the tire casing 112 surface at a post-buff location provides an amount of removed casing material. The controller 104 may check the amount of removed casing material with the belt depth provided by the belt sensor 106, and adjust the cut depth of the buffer for the next buff pass accordingly. The controller 104 may automatically reverse the roles of the distance sensors 108 and 110 as well as the roles of the belt sensors 310 and 312 as the rasp proceeds to move in the opposite direction from the direction indicated in FIG. 4B.

As such, through the measurements and calculations discussed above, the controller 104 may continuously or periodically (e.g., once per rotation of the tire casing 112) monitor the amount of tire material removed during the buffing process (e.g., difference between the pre-buff distance and the post-buff distance to the tire casing 112), as well as the amount of material between the belts 114 and the crown surface of the tire casing 112. In response to the measurements and calculations with respect to the tire casing 112, the controller 104 may adjust the buffing process to prevent over or under-buffing of the tire casing 112 (e.g., adjusting a buffer cut depth). In some arrangements, the controller 104 may be configured to halt the operation of the rasp 306 if the belt depth meets or exceeds a predetermined minimum belt depth (e.g., as indicated in a corresponding casing profile in the database). For example, the controller 104 may determine that the belts 114 are 4/32″ below the surface of the tire casing 112, and the current cut depth of the buffer is set for 3/32″ per pass. Where the target belt depth is 2/32″ below the crown surface of the tire casing 112, the controller 104 may reduce the cut depth of the buffer from 3/32″ to 2/32″, and as such, the next buffing pass will yield a belt depth of 2/32″.

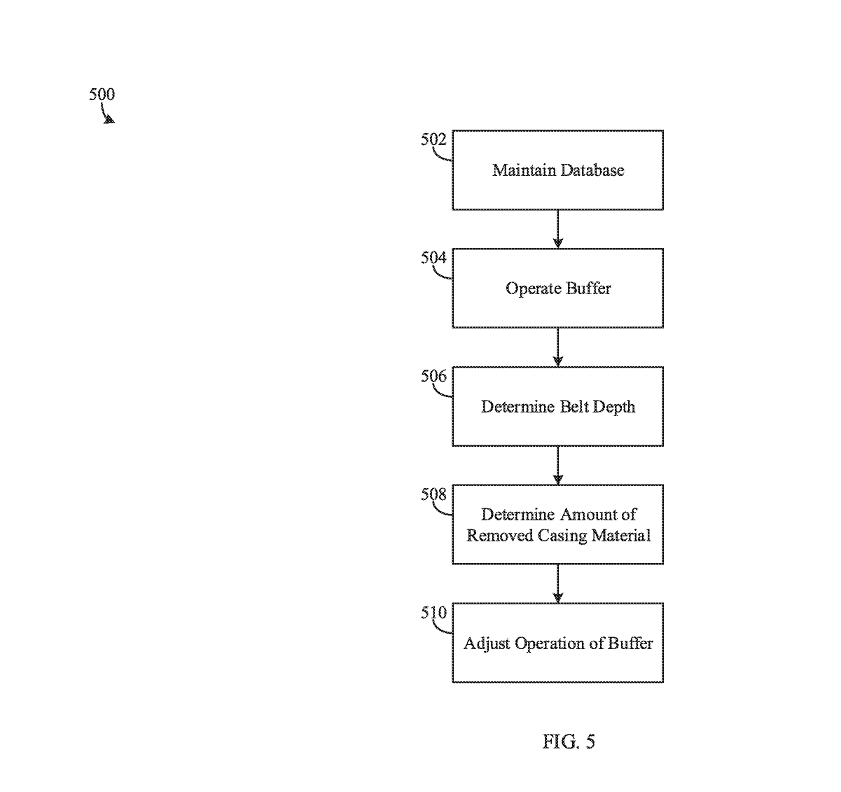

Referring now to FIG. 5, a method 500 of buffing a tire casing using a buffer (e.g., the buffer 100) with a controller (e.g., the controller 104) is provided. At 502, a database (e.g., the database of the controller 104) maintains instructions carried out by the controller, including instructions for buffing procedures. The database also maintains information relating to a plurality of buffing parameter profiles (e.g., desired crown and shoulder characteristics, minimum belt depths, etc.) corresponding to a plurality of tire casing sizes and specifications.

At 504, the buffer is operated to buff a mounted tire casing (e.g., the tire casing 112) pursuant to parameters for a buffer parameter profile maintained the database. The tire casing may be buffed to position a set of belts (e.g., the belts 114) at a predetermined depth beneath the crown surface of the tire casing. A belt sensor (e.g., the belt sensor 106) measures the depth of the belts at 506, which may be performed on a continuous or periodic basis (e.g., once for every rotation of the tire casing). A first distance sensor (e.g., the first distance sensor 108) disposed toward the crown surface of the tire casing at a pre-buff location and a second distance sensor (e.g., the second distance sensor 110) disposed toward a post-buff location determines an amount of removed casing material at 508. Using data collected at 506 and 508, the controller adjusts the operation of the buffer at 510 to prevent over-buffing the tire casing.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise indicated.

While the invention is described herein in connection with certain preferred embodiments, there is no intent to limit the present invention to those embodiments. On the contrary, it is recognized that various changes and modifications to the described embodiments will be apparent to those skilled in the art upon reading the foregoing description, and that such changes and modifications may be made without departing from the spirit and scope of the present invention. The inventors expect skilled artisans to employ such variations as appropriate, and the inventors intend for the invention to be practiced otherwise than as specifically described herein. Accordingly, the intent is to cover all alternatives, modifications, and equivalents included within the spirit and scope of the invention. Moreover, any combination of the above-described elements in all possible variations thereof is encompassed by the invention unless otherwise indicated herein or otherwise clearly contradicted by context.

1. A tire buffing machine, comprising:
a tire hub assembly selectively rotating a casing mounted thereon;
a buffer configured to buff the casing mounted on the tire hub assembly;
a first measurement subsystem comprising at least one electromagnetic transmitter and sensor directed toward at least one belt in the casing;
a second measurement subsystem comprising a first distance sensor directed toward a pre-buff location on a casing surface and a second distance sensor directed toward a post-buff location on the casing surface; and
an electronic controller communicatively coupled to the buffer, the first measurement subsystem, and the second measurement subsystem, the electronic controller being programmed to:
determine at least one belt depth based on electromagnetic transmitter and sensor data received by the first measurement subsystem;
determine an amount of removed casing material based on pre-buff casing distance data and post-buff casing distance data received by the second measurement subsystem; and
adjust the operation of the buffer based on the at least one belt depth and the amount of removed casing material.

2. The tire buffing machine of claim 1, wherein the buffer includes a rasp housing containing an exposed rasp disposed toward the casing, and wherein the second measurement subsystem is mounted to the rasp housing.

3. The tire buffing machine of claim 2, wherein the first measurement subsystem is mounted to the rasp housing.

4. The tire buffing machine of claim 3, wherein the sensors of the first measurement subsystem and the second measurement subsystem are disposed on a common plane that includes the rotational axis of the rasp.

5. The tire buffing machine of claim 1, wherein the first measurement subsystem includes a first electromagnetic transmitter and sensor oriented toward a pre-buff location on the casing surface and a second electromagnetic transmitter and sensor oriented toward a post-buff location on the casing surface.

6. The tire buffing machine of claim 1, wherein the controller adjusts a cut depth of the buffer based on the belt depth and the amount of removed casing material.

7. The tire buffing machine of claim 1, wherein the controller is configured to stop the operation of the buffer if the belt depth reaches a predetermined minimum depth.

8. A tire buffing machine having a controller enabling the tire buffing machine to buff a casing while monitoring the location of a belt package disposed therein, the controller including instructions stored on non-transient data media causing the controller to perform operations comprising:
maintaining a database containing a plurality of casing profiles, each casing profile including corresponding buffing parameters;
operating a buffer to buff the casing in accordance with buffing parameters associated with one of the plurality of casing profiles;
determining at least one belt depth based on electromagnetic transmitter and sensor data received by a first measurement subsystem comprising at least one electromagnetic transmitter and sensor;
determining an amount of removed casing material based on pre-buff casing distance data and post-buff casing distance data received by a second measurement subsystem comprising a first distance sensor oriented towards a pre-buff location on the casing and a second distance sensor oriented towards a post-buff location on the casing; and
adjusting the operation of the buffer based on at least one belt depth and the amount of removed casing material.

9. The tire buffing machine of claim 8, wherein the buffer includes a rasp housing containing an exposed rasp disposed toward the casing, and wherein the second measurement subsystem is mounted to the rasp housing.

10. The tire buffing machine of claim 9, wherein the first measurement subsystem is mounted to the rasp housing.

11. The tire buffing machine of claim 10, wherein the sensors of the first measurement subsystem and the second measurement subsystem are disposed on a common plane that includes the rotational axis of the rasp.

12. The tire buffing machine of claim 8, wherein the first measurement subsystem includes a first electromagnetic transmitter and sensor oriented toward a pre-buff location on the casing surface and a second electromagnetic transmitter and sensor oriented toward a post-buff location on the casing surface.

13. The tire buffing machine of claim 8, wherein the controller adjusts a cut depth of the buffer based on the belt depth and the amount of removed casing material.

14. The tire buffing machine of claim 8, wherein the controller is configured to stop the operation of the buffer if the belt depth reaches a predetermined minimum depth specified in the one of the plurality of casing profiles.

15. A method of manufacturing a retreaded tire casing, the method comprising:
maintaining, in a database, a plurality of casing profiles, each casing profile including corresponding buffing parameters;
operating a buffer to buff the casing in accordance with buffing parameters in one of the plurality of casing profiles;
determining, by a controller, at least one belt depth based on electromagnetic transmitter and sensor data received by a first measurement subsystem comprising at least one electromagnetic transmitter and sensor;
determining, by the controller, an amount of removed casing material based on pre-buff casing distance data and post-buff casing distance data received by a second measurement subsystem comprising a first distance sensor oriented towards a pre-buff location on the casing and a second distance sensor oriented towards a post-buff location on the casing; and
adjusting, by the controller, the operation of the buffer based on the at least one belt depth and the amount of removed casing material.

16. The method of claim 15, wherein the buffer includes a rasp housing containing an exposed rasp disposed toward the casing, and wherein the second measurement subsystem is mounted to the rasp housing.

17. The method of claim 16, wherein the first measurement subsystem is mounted to the rasp housing.

18. The method of claim 17, wherein the sensors of the first measurement subsystem and the second measurement subsystem are disposed on a common plane that includes the rotational axis of the rasp.

19. The method of claim 15, wherein the first measurement subsystem includes a first electromagnetic transmitter and sensor oriented toward a pre-buff location on the casing surface and a second electromagnetic transmitter and sensor oriented toward a post-buff location on the casing surface.

20. The method of claim 15, wherein the controller is configured to stop the operation of the buffer if the belt depth reaches a predetermined minimum depth specified in the one of the plurality of casing profiles.
